(19) United States
(12) Patent Application Publication
(10) Pub. No.: US 2015/0068678 A1
(43) Pub. Date: Mar. 12, 2015

(54) METHOD AND DEVICE FOR PRODUCING A COMPOSITE MATERIAL

(71) Applicant: KARL MAYER MALIMO TEXTILMASCHINENFABRIK GMBH, Chemnitz (DE)

(72) Inventors: Rene GLOECKNER, Eppendorf (DE); Lutz PANDER, Chemnitz (DE); Jan GRUENERT, Chemnitz (DE)

(21) Appl. No.: 14/485,304

(22) Filed: Sep. 12, 2014

Related U.S. Application Data
(62) Division of application No. 13/492,235, filed on Jun. 8, 2012, now abandoned.

(30) Foreign Application Priority Data
Feb. 22, 2012 (EP) 12001195.2

(51) Int. Cl. B29C 70/20

(52) U.S. Cl. CPC B29C 70/202; B29K 2105/0881
USPC 156/324; 156/439

(57) ABSTRACT

Method and device for producing a composite material. The method includes feeding at least two semi-finished webs in their respective longitudinal direction, placing one of the at least two semi-finished webs on top of an other of the at least two semi-finished webs, and connecting the at least two semi-finished webs to one another. Each semi-finished web has fibers fixed in a unidirectionally oriented manner, and, in at least one of the at least two semi-finished webs, the fibers enclose a predetermined angle greater than 0° to the longitudinal direction.

### CROSS-REFERENCE TO RELATED APPLICATIONS

The present application is a divisional of U.S. patent application Ser. No. 13/492,235, filed Jun. 8, 2012, the disclosure of which is expressly incorporated by reference herein in its entirety. Additionally, the present application claims priority under 35 U.S.C. §119 of European Patent Application No. 12 001 195.2, filed on Feb. 22, 2012, the disclosure of which is expressly incorporated by reference herein in its entirety.

### BACKGROUND OF THE INVENTION

1. Field of the Invention

The invention relates to a method for producing a composite material. Furthermore, the invention relates to a device for producing a composite material.

2. Discussion of Background Information

Components of fiber-reinforced plastic are used in many fields of technology. Components of fiber-reinforced plastic have the advantage over metal components of higher specific mechanical properties. Furthermore, plastics can also be used in areas where metals would corrode.

EP 2 301 735 A2 (and its counterpart U.S. Patent Publication No. US 2011/0076441), the disclosures of which are expressly incorporated by reference herein in their entireties, shows a semi-finished product and a semi-finished product composite as well as production methods for this semi-finished product. Fibers fixed in a unidirectionally oriented manner are arranged between two layers of thermoplastic material. This composite then forms a type of “metal sheet” that can be shaped in a similar manner to a metal sheet. This semi-finished product has a relatively high tensile strength in the direction in which the fibers extend. The tensile strength is much lower in a direction transverse to the longitudinal extension of the fibers. In order to increase the tensile strength, several semi-finished products of this type are arranged one above the other, wherein the angular positions of the fibers differ from one another.

Another way of producing a semi-finished product with an increased tensile strength in several directions lies in the production of a so-called “multi-axial scrim.” Here several thread sheets are used, which are placed one on top of the other. The threads are arranged in a unidirectional manner in each thread sheet. The directions of the threads then differ among the thread sheets.

In both cases, the production of a composite material or of a multiaxial scrim requires a substantial expenditure. When the threads or fibers are to have different directions, the thread sheets or semi-finished products must also be fed from different directions. This requires a relatively large installation space and as a rule also a relatively complicated control, because the individual feeder rolls have to be coordinated with one another.

### SUMMARY OF THE INVENTION

Embodiments of the instant facilitate the production of multiaxially reinforced materials.

Accordingly, a method for producing a composite material having at least two semi-finished webs being fed in their longitudinal direction, placed one on top of the other and connected to one another. Each semi-finished web has fibers fixed in a unidirectionally oriented manner, and in at least one of the semi-finished webs, the fibers enclose a predetermined angle greater than 0° to the longitudinal direction of the semi-finished web.

Since the semi-finished webs respectively can be fed in their longitudinal direction, comparatively little installation space is necessary. The control of the feed of the webs can also be designed in a simple manner because no complicated conversions have to be made in which the angles of fed fibers or fiber sheets have to be taken into consideration.

Preferably, the at least two semi-finished webs have different predetermined angles. If more than two semi-finished webs are used, then two of these semi-finished webs can also have the same angles. However, as the angles of the at least two semi-finished webs differ, an increased tensile strength can be realized in at least two directions.

Preferably, the semi-finished webs are connected to one another under temperature treatment. The application of an increased temperature is generally easily possible. The temperature increase can, for example, soften the surface of at least one semi-finished web to the extent that it becomes sticky and adheres to another semi-finished web.

Preferably, with more than two semi-finished webs, a connection between two adjacent semi-finished webs is carried out before a further semi-finished web is added. If, for example, a first semi-finished web and a second semi-finished web are placed one on top of the other, then these two semi-finished webs can be connected to one another before a third semi-finished web is placed onto the second semi-finished web. The third semi-finished web is then connected to the second semi-finished web before the fourth semi-finished web is deposited, and so on. In particular, connecting the semi-finished webs with the supply of heat has considerable advantages because the heat has to penetrate respectively only one semi-finished web.

Alternatively, at least three semi-finished webs are combined in a fan-like manner and the semi-finished webs are connected to one another simultaneously. Connection aids are arranged in the spaces between the semi-finished webs. Of course, more than the three referenced semi-finished webs can be connected to one another at the same time. An embodiment of this type creates a very homogenous structure of the composite material in the thickness direction. The connection aids prepare the surfaces of the semi-finished webs respectively such that they can be connected to the adjacent semi-finished webs.

Preferably, the semi-finished webs are unwound from rolls, the rotational axes of which are aligned parallel to one another. These rolls can then be arranged in the longitudinal direction one behind the other. To produce the composite material, it is then necessary merely to unwind or draw off the semi-finished webs from the rolls. In many cases, a drive of the rolls is not even necessary. The control is thereby kept relatively simple.

Preferably, adjacent semi-finished webs are connected to one another by adhesive force. With an adhesive connection, the semi-finished webs are, e.g., welded or adhered to one another. The adhesion can be carried out in such a manner that an adhesive is introduced between the adjacent semi-finished webs in order to then connect the two adjacent semi-finished webs to one another. A solvent can also be introduced, which partially dissolves the surface of at least one semi-finished web so that it connects to the surface of the adjacent semi-finished web. Of course, the type of connection is determined by the plastic or matrix material of the connected semi-finished webs used.

Preferably, the semi-finished webs are connected to one another by the application of pressure. Often an improved connection between adjacent semi-finished webs results with increased pressure. The action of pressure can be used at the same time to calibrate the composite material.

Embodiments of the invention are directed to a device for producing a composite material. The device includes at least two dispensing devices, each of which dispenses a semi-finished web along its longitudinal direction, a connection device for connecting the semi-finished webs, and a dispensing device. Each semi-finished web has fibers fixed in a unidirectionally oriented manner, and in at least one of the semi-finished webs, the fibers enclose a predetermined angle greater than 0° to the longitudinal direction of the semi-finished web.

Through the use of semi-finished webs with correspondingly oriented fiber directions, a composite material can be produced, which with respect to its tensile strength can be designed relatively precisely in line with the requirements.

Preferably, at least two of the semi-finished webs have different predetermined angles. With a device of this type, a composite material can be produced which has at least two fiber layers with different angles to the longitudinal direction. Accordingly, this composite material has an increased tensile strength in both directions of the fiber layers.

Preferably, at least one dispensing device has a supply roll. The semi-finished web can then be unwound from this supply roll. This facilitates the stockpiling.

It is preferred that at least two dispensing devices respectively have a supply roll and the axes of the supply rolls are aligned parallel to one another. These rolls can then be arranged in the longitudinal direction for example one behind the other or one on top of the other. To produce the composite material, it is then necessary merely to unwind or draw off the semi-finished webs from the supply rolls. A deflection is not absolutely necessary.

Preferably, the connection device has a heat source. The heat source can be used to increase the temperature of at least one semi-finished web. Depending on the desired connection between adjacent semi-finished webs, the temperature can then be set so high that adjacent semi-finished webs are welded to one another.

Alternatively or additionally, the connection device has a dispenser for adhesive and/or solvent. The adhesive can then be used to adhere adjacent semi-finished webs to one another. If a solvent is used that partially dissolves the surface of the semi-finished web, this solvent can be applied and the surfaces then partially dissolved can then be attached to one another. Some adhesives also adhere better when the opposite surface has been pretreated with a solvent. Some adhesives also adhere better or more quickly if heat is supplied.

Preferably, a pressure device is provided, which presses at least two semi-finished webs onto one another for connection. An increased pressure generally leads to an improved adhesive bond.

It is preferred that the pressure device has at least one pair of rolls. The pair of rolls then forms a nip, through which the composite material, i.e., the stack of at least two semi-finished webs, is then guided.

Embodiments of the instant invention are directed to a method for producing a composite material. The method includes feeding at least two semi-finished webs in their respective longitudinal direction, placing one of the at least two semi-finished webs on top of an other of the at least two semi-finished webs, and connecting the at least two semi-finished webs to one another. Each semi-finished web has fibers fixed in a unidirectionally oriented manner, and, in at least one of the at least two semi-finished webs, the fibers enclose a predetermined angle greater than 0° to the longitudinal direction.

According to embodiments of the invention, the fibers of the at least two semi-finished webs can be oriented at different angles to their respective longitudinal direction. The at least two semi-finished webs can be connected to one another under temperature treatment.

In accordance with other embodiments, the at least two semi-finished webs may include more than two semi-finished webs, and the method can further include connecting two adjacent semi-finished webs before connecting a further semi-finished web.

According to still other embodiments of the invention, the at least two semi-finished webs can include at least three semi-finished webs, and the method may further include combining the at least three semi-finished webs a fan-like manner and simultaneously connecting the at least three semi-finished webs to one another.

According to further embodiments, the method can include unwinding the semi-finished webs from rolls. Rotational axes of the rolls can be aligned parallel to one another.

According to other embodiments of the present invention, an adhesive force may connect adjacent semi-finished webs to one another.

The method may also include applying pressure to the semi-finished webs to connect them to one another.

Embodiments of the invention are directed to a device for producing a composite material. The device includes at least two dispensing devices, each of which are structured and arranged to dispense a semi-finished web along its longitudinal direction, and a connection device for connecting the at least two semi-finished webs. Each semi-finished web has fibers fixed in a unidirectionally oriented manner, and, in at least one of the at least two semi-finished webs, the fibers enclose a predetermined angle greater than 0° to the longitudinal direction.

According to embodiments, the at least two semi-finished webs can be oriented at different angles to their respective longitudinal direction.

In accordance with other embodiments, at least one of the at least two dispensing devices can have a supply roll. Further, the at least two dispensing devices may have supply rolls and the axes of the supply rolls can be aligned parallel to one another.

According to still other embodiments of the invention, the connection device can include a heat source.

In accordance with other embodiments, the connection device may include a dispenser for at least one of adhesive and solvent.

According to still other embodiments, the device can further include a pressure device structured and arranged to press and connect the at least two semi-finished webs onto one another. Further, the pressure device can include at least one pair of rolls.

Moreover, the connection device may include a heating device for heating a surface of at least one of the at least two semi-finished web before the at least two semi-finished webs are connected to one another.

In accordance with still yet other embodiments of the present invention, the at least two dispersing devices can include at least three dispersing devices arranged to feed respective semi-finished webs in a fan-like manner. The connecting device may be arranged to simultaneously connect the at least three semi-finished webs to one another.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates an exemplary production of a semi-finished web.

FIG. 2 diagrammatically illustrates an exemplary device for producing a composite material according to embodiments of the invention; and

FIG. 3 diagrammatically illustrates a modified exemplary device for generating a composite material according to embodiments of the invention.

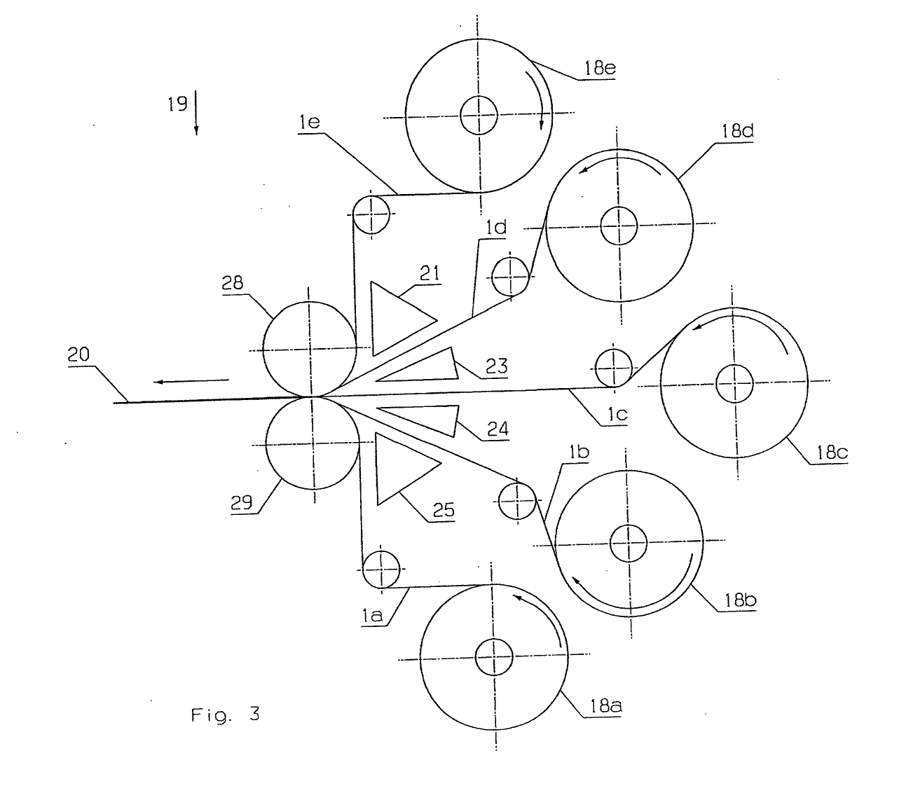

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

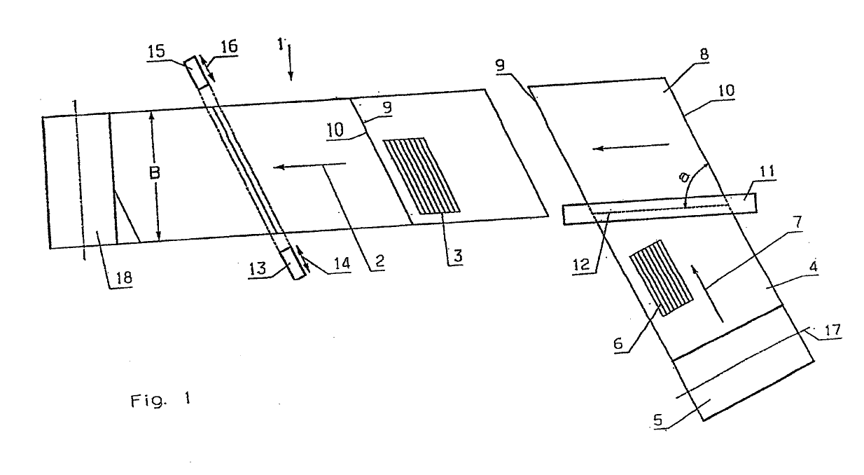

FIG. 1 shows in a very diagrammatic form a semi-finished web 1, which has a longitudinal direction 2 symbolized by an arrow and a plurality of fibers 3 fixed in a unidirectionally oriented manner. Fibers 3 run at a predetermined angle a to longitudinal direction 2 and are embedded in a matrix of plastic, not shown in further detail.

In order to produce semi-finished web 1, a supply web 4 is used. Supply web 4 can be unwound, e.g., from a supply roll 5. Optionally, several supply rolls 5 can also be arranged next to one another and correspondingly several supply webs 4 can be drawn off at the same time. However, supply web 4 can also be produced online. Optionally, supply web 4 can already be in the form of segments that can be stored and removed from a storage unit or magazine.

The web of a semi-finished product, which is described in EP 2 301 735 A2 and its counterpart U.S. Patent Publication No. US 2011/0076441, the disclosures of which are expressly incorporated by reference herein in their entireties, can be used as supply web 4. Supply web 4 can thus have a plurality of fibers 6 that are fixed in a unidirectionally oriented manner and that are arranged between two layers of thermoplastic material. Other structures are also conceivable, of course, within the skill of the ordinarily skilled artisan. However, supply web 4 has a matrix of a plastic that holds fibers 6 in their unidirectionally oriented alignment.

Supply web 4 has a main direction 7 indicated by an arrow. In this regard, it is noted that, while main direction 7 is the “longitudinal direction” of supply web 4, the term “main direction” is used in this application for the purpose of differentiation and ease of explanation. Fibers 6 are aligned in the direction of main direction 7, i.e., they run parallel to the main direction 7. As used in this application, the term “parallel” is not being used in the strict mathematical sense, but is understood to mean that fibers 6 generally extend in the same direction as main direction 7

As can be seen from the figure, segments 8 are separated from supply web 4. Each segment has two longitudinal edges 9, 10, which are aligned parallel to main direction 7 and thus parallel to fibers 6. Longitudinal edges 9, 10 are likewise oriented at predetermined angle a relative to longitudinal direction 2

A separating device 11 is used to separate segments 8 from supply web 4. Separating device 11 severs supply web 4, e.g., with the aid of ultrasound, with a knife, with scissors, with a band knife, with a falling knife or guillotine, or with some other suitable severing device. Separating device 11 thereby produces a separation line 12, which is oriented parallel to longitudinal direction 2, while supply web 4 is fed to separating device 11 at angle a relative to the longitudinal direction 2.

Separating device 11 separates segments 8 to have a width B of semi-finished web 1 so that a length of longitudinal edges 9, 10 of segment 8 corresponds to width B divided by the cosine of angle a. Thus, it is understood that longitudinal edges 9, 10 are longer than width B of semi-finished web 1. However, they are exactly so large that the segments 8 can later be assembled to form semi-finished web 1 with desired width B.

Since separation line 12 lies parallel to longitudinal direction 2, a change of direction of segments 8 before the joining to form semi-finished web 1 is no longer necessary.

Of course, segments 8 can also be removed from a magazine or a storage unit in which they have previously been deposited.

Segments 8 are deposited one after the other on a conveyor device, not shown in greater detail, and conveyed in longitudinal direction 2. As soon as sufficient space is available, the next segment 8 is deposited on the conveyor device. The representation in FIG. 1 shows a segment 8 separated from semi-finished web 1. This representation is intended to facilitate and simplify the explanation of the process. In fact, segment 8 is deposited following the already completed portion of semi-finished web 1.

If segments 8 are connected to one another immediately after being deposited, semi-finished web 1 may itself forms the conveyor device, i.e., space for the next segment 8 is created by a pull on semi-finished web 1.

The connection of adjacent segments 8 on their longitudinal edges 9, 10 can be carried out in different ways. The longitudinal edges 9, 10, for example, can be placed edge to edge and welded to one another by the application of heat or ultrasound. A strip overlapping the longitudinal edges 9, 10 can also be used, which strip is formed of the same material as the matrix material of the supply web 4, and this strip can then be welded or adhered to the segments 8. An adhesive strip can also be used or the longitudinal edges 9, 10 lying edge to edge can be adhered to one another directly. To this end, for example, a hot adhesive can be used. Adjacent segments 8 can also be allowed to overlap in the region of their longitudinal edges and then can be fused to one another. For heat supply, conventional sources such as laser, hot air or infrared radiation are possible.

The connection of adjacent segments 8 on their longitudinal edges 9, 10 can be carried out in different ways. Longitudinal edges 9, 10 can be placed, e.g., edge to edge and welded to one another by the application of heat or ultrasound. A strip overlapping the longitudinal edges 9, 10 can also be used. In this regard, the strip can be formed of the same material as the matrix material of supply web 4, and this strip can then be welded or adhered to segments 8. Still further, an adhesive strip can also be used or longitudinal edges 9, 10 lying edge to edge can be adhered to one another directly. To this end, for example, a hot adhesive can be used. Adjacent segments 8 can also be allowed to overlap in the region of their longitudinal edges and then can be fused to one another. For heat supply, conventional sources such as laser, hot air or infrared radiation are possible.

A connection device 13 is shown diagrammatically, which can be guided over semi-finished web 1 in the direction of a double arrow 14, i.e., over the two adjacent longitudinal edges 9, 10 of adjacent segments 8. A pressure device 15 is likewise diagrammatically shown, which can be guided over semi-finished web 1 in the direction of a double arrow 16. Connection device 13 and pressure device 15 can act separately from one another or jointly. In the latter case, they can also be embodied or formed as a common assembly.

Connection device 13 can be displaced in longitudinal direction 2 during the connection of adjacent segments 8, when the transport device is moved continuously in order to convey the semi-finished web 1 continuously. Connection device 13 (the same naturally also applies to the pressure device 15), however, can also be held in a stationary manner in the longitudinal direction 2 when the conveyor device is activated in a clocked manner.

The production of another semi-finished web in which fibers 6 are oriented at an angle b relative to longitudinal direction 2 that is different from angle a is relatively easily possible by changing the angular relation between main direction 7 and longitudinal direction 2. For this it is often necessary merely to change the direction of axis 17 of supply roll 5. In a similar manner, the directions of movement 14, 16 of connection device 13 and of pressure device 15 must also be changed. However, the position and the location of separation device 11 can be left unchanged.

In a manner not shown in further detail, a coupling device can be provided, which transfers the angular alignment of supply roll 5 to connection device 13 and pressure device 15 so that connection device 13 and pressure device 15 can be moved along longitudinal edges 9, 10 of adjacent segments 8, even if the angular orientation is changed.

Semi-finished web 1 can be wound up to form a lap roll 18, in order to simplify its handling.

If a semi-finished web 1 with a different angular orientation of fibers 6 to longitudinal direction 2, i.e., different from angle a, is to be produced, alternatively or additionally to changing the direction of axis 17 of supply roll 5, the winding direction which is defined by the axis of lap roll 18 can also be changed.

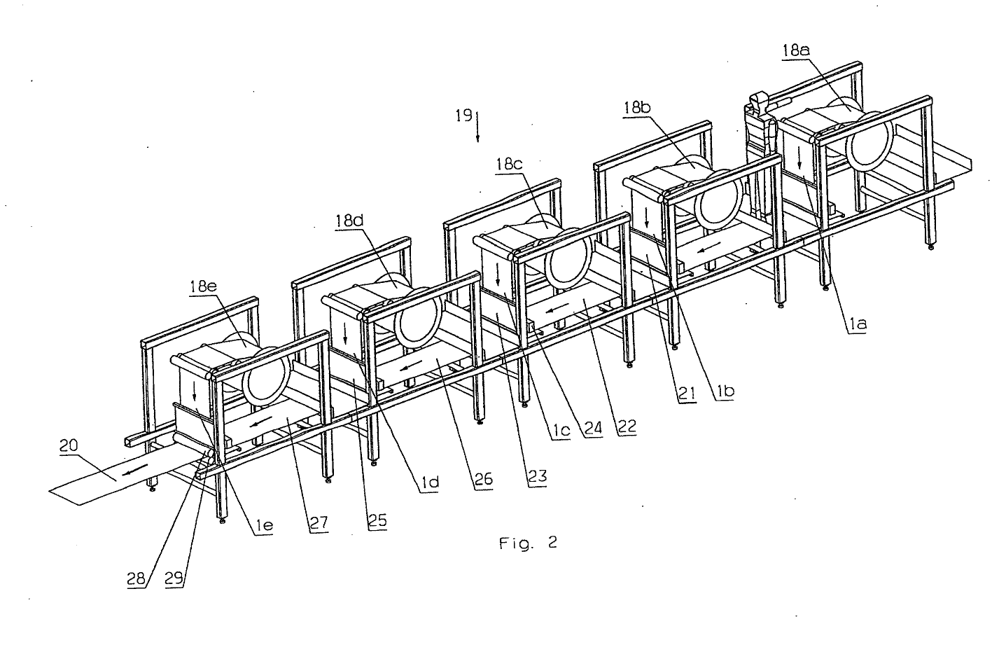

FIG. 2 shows in a very diagrammatic form a device 19 for producing a composite material 20. Composite material 20 in this case is formed by five semi-finished webs 1a-1e, which are unwound from five lap rolls 18a-18e. A different number of semi-finished webs are also possible in accordance with the skill of the ordinarily skilled artisan reviewing the pending disclosure of the embodiments.

Lap rolls 18a-18e have rotational axes aligned parallel to one another, so that the individual semi-finished webs 1a-1e can also be fed parallel to one another.

At first only two semi-finished webs 1a, 1b are placed one on top of the other and connected, e.g., welded or adhered to one another. As soon as the connection has been made, the next semi-finished web 1c is placed on connected semi-finished webs 1a and 1b and connected to semi-finished web 1b, which lies beneath it. The fourth semi-finished web 1d is then placed on the composite of three semi-finished webs 1a-1c and connected to the stack of semi-finished webs 1a1c lying beneath, and more particularly to semi-finished web 1c. Finally, the fifth semi-finished web le is placed and connected to the already completed stack.

By way of non-limiting example, before the connection of adjacent semi-finished webs is carried out, an adhesive can be applied to one or both semi-finished webs to be placed one on top of the other. It is also possible to soften one or both semi-finished webs on their surfaces by heat or chemical agents so that they can be connected to one another after being placed one on top of the other. Additionally or alternatively, pressure can also be applied to facilitate the connection of the semi-finished web.

Heat can also be guided through a semi-finished web after it has been brought to bear against another semi-finished web, in order to produce a welding. This heat impingement should take place before a further semi-finished web is deposited, so that the heat needs only to penetrate one single semi-finished web.

FIG. 2 shows various exemplary and different possibilities for connecting to one another semi-finished webs lying one on top of the other. The sequence of connecting processes is a non-limiting example, and it is understood that other sequences, including utilizing only a single process for each connection can be utilized without departing from the spirit of the pending invention. In the illustrated embodiment, in the module in which supply roll 18b is stored, an adhesive application device 21 is provided, with which adhesive is applied to the side of semi-finished web 1b that is brought to bear against semi-finished web 1a.

When assembled, a first intermediate product 22 of composite material 20 is then produced from two semi-finished webs 18a, 18b.

For semi-finished web 1c, which is unwound from the supply roll 18c, a heating device 23 is provided which heats the semi-finished web 1c on the side facing towards the intermediate product 22 and makes this side sticky to the extent that it adheres to the intermediate product 22, that is formed from the semi-finished webs 1a, 1b. In addition, a further heating device 24 can be provided, which heats the top of intermediate product 22 facing towards semi-finished web 1c in order to improve the adhesion or welding of semi-finished web 1c with intermediate product 22.

For semi-finished web 1d, a welding device 25 is provided in order to introduce into semi-finished web 1d the heat necessary for welding. This heat penetrates this semi-finished web 1d and heats it so that it is welded to an intermediate product 26, which is assembled from semi-finished webs 1a, 1b, 1c.

Intermediate product 26 joined together with semi-finished web Id forms an intermediate product 27, which will be joined together with semi-finished web 1d as both are guided through a nip formed between two pressure rollers 28, 29. Pressure is applied by pressure rollers 28, 29. Optionally, before applying the pressure, an adhesive can be applied to semi-finished web 1e or a corresponding preparation can connect semi-finished web 1e to intermediate product 27 in order to form composite material 20.

The individual types of connection were listed here merely non-limiting examples for connecting the semi-finished webs. In many cases it is expedient to connect all of the semi-finished webs 1a, 1b, and 1c to one another in the same way. If different types of connection are selected, a different sequence of the types of connection is also possible.

Five semi-finished webs 1a-1e do not have to be used. The concrete number of semi-finished webs 1a-1e to be used is determined by the application purpose. However, at least two semi-finished webs are used and the number is virtually unlimited upwards. It is also possible to connect ten or more semi-finished webs to one another to form the composite material 20.

At least two of the five semi-finished webs 1a-1e have different angles a between unidirectionally oriented fibers 3 and longitudinal direction 2. In many cases it is favorable to provide all five semi-finished webs 1a-1e with different fiber orientations relative to longitudinal direction 2.

Although theoretically all semi-finished webs 1a-1e can have the same angle, generally at least two different angular alignments are used, depending on the demands made of semi-finished product 20.

Device 19 is designed in a relatively simple manner. In principle, several modules of the same kind can be used. Since these modules can be arranged one behind the other, relatively little installation space is necessary.

Composite material 20 can also be produced so that semi-finished webs 1a-1e are assembled in a fan-shaped manner, which is shown in the figure from the side. In the spaces between individual semi-finished webs 1a-1e, heating fields are provided to heat the surfaces of semi-finished webs 1a-1e by, e.g., radiant heat or contact heat. Alternatively, of course, adhesive application devices can be provided in the spaces. In both cases, all of the semi-finished webs 1a-1e are pressed against one another simultaneously and thus are connected in order to form composite material 20.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for producing a composite material, comprising:
unwinding at least three semi-finished webs from rolls, wherein rotational axes of the rolls are aligned parallel to one another;
feeding the at least three semi-finished webs in their respective longitudinal direction;
placing the at least three semi-finished webs on top of one another; and
simultaneously connecting the at least three semi-finished webs to one another, wherein each semi-finished web has fibers embedded in thermoplastic material and fixed in a unidirectionally oriented manner, and, in at least one of the at least three semi-finished webs, the fibers enclose a predetermined angle greater than 0° to the longitudinal direction.

2. The method according to claim 1, wherein the fibers of two of the at least three semi-finished webs are oriented at different angles to their respective longitudinal direction.

3. The method according to claim 1, wherein the at least three semi-finished webs are connected to one another under temperature treatment.

4. The method according to claim 1, wherein the at least three semi-finished webs comprise more than three semi-finished webs.

5. The method according to claim 1, the method further comprising combining the at least three semi-finished webs a fan-like manner.

6. The method according to claim 1, wherein an adhesive force connects adjacent semi-finished webs to one another.

7. The method according to claim 1, further comprising applying pressure to the semi-finished webs to connect them to one another.

8. A device for producing a composite material, comprising:
at least three dispensing devices, each of which are structured and arranged to dispense a semi-finished web along its longitudinal direction; and
a connection device for simultaneously connecting the at least two semi-finished webs,
wherein each semi-finished web has fibers embedded in thermoplastic material and fixed in a unidirectionally oriented manner, and, in at least one of the at least two semi-finished webs, the fibers enclose a predetermined angle greater than 0° to the longitudinal direction, and
wherein the at least three dispensing devices have supply rolls and the axes of the supply rolls are aligned parallel to one another.

9. The device according to claim 8, wherein the at least two semi-finished webs are oriented at different angles to their respective longitudinal direction.

10. The device according to claim 8, wherein at least one of the at least two dispensing devices has a supply roll.

11. The device according to claim 8, wherein the connection device comprises a heat source.

12. The device according to claim 8, wherein the connection device comprises a dispenser for at least one of adhesive and solvent.

13. The device according to claim 8, further comprising a pressure device structured and arranged to press and connect the at least two semi-finished webs onto one another.

14. The device according to claim 13, wherein the pressure device comprises at least one pair of rolls.

15. The device according to claim 8, wherein the connection device comprises a heating device for heating a surface of at least one of the at least three semi-finished web before the at least three semi-finished webs are connected to one another.

16. The device according to claim 8, wherein the at least three dispersing devices arranged to feed respective semi-finished webs in a fan-like manner.
